(19) United States
(12) Patent Application Publication
(10) Pub. No.: US 2016/0017901 A1
(43) Pub. Date: Jan. 21, 2016

(54) PRESSURE LOSS REDUCING CIRCUIT FOR A WORKS MACHINE

(71) Applicant: CATERPILLAR SARL, Geneva (CH)

(72) Inventors: Yuya KANENAWA, Tokyo (JP); Shuhei ORIMOTO, Tokyo (JP); Genta MINE, Tokyo (JP); Yudai ADOMI, Tokyo (JP); Yutaka YOKOYAMA, Tokyo (JP)

(21) Appl. No.: 14/773,288

(22) PCT Filed: Feb. 27, 2014
(86) PCT No.: PCT/EP2014/025003

§ 371 Date: Sep. 4, 2015

(30) Foreign Application Priority Data
Mar. 6, 2013 (JP) 2013-044119

(51) Int. Cl. F15B 21/08; E02F 9/22; F15B 11/16

(52) U.S. Cl. CPC F15B 21/08; F15B 11/165; E02F 9/2235; E02F 9/2267; E02F 9/2203; F15B 2211/205; F15B 2211/25

(57) ABSTRACT

A pressure loss reducing circuit reduces a pressure loss of oil returning from an actuator to a direction switching valve with a simple configuration while suppressing an increase in the manufacturing cost and substantially eliminating the need of an additional installation space. The pressure loss reducing circuit includes a bypass valve disposed between an actuator oil path and a tank oil path of a direction switching valve, and opened and closed according to a signal from a controller, and moreover screwed into and attached to the direction switching valve. According to an operation signal of a switching spool when oil returning from an actuator is caused to flow to the actuator oil path, the controller opens the bypass valve so that the actuator oil path and the tank oil path communicate with each other and supplies the returning oil to the switching spool and the bypass valve to reduce a pressure loss.

### CROSS-REFERENCE TO RELATED APPLICATIONS

This application is a National Stage of International Patent Application No. PCT/EP2014/025003, filed Feb. 27, 2014, which claims priority to foreign Japanese Patent Application No. 2013-044119, filed Mar. 6, 2013, the content of which are incorporated herein by reference in their entirety.

### TECHNICAL FIELD

The present invention relates to a circuit that reduces a pressure loss of hydraulic oil returning from a hydraulic actuator to a direction switching valve.

### BACKGROUND

A work machine (as a typical example, a hydraulic shovel) includes a large number of actuators like cylinders to perform works. The actuator operates with the oil pumped from a pump and supplied by a direction switching valve that is operated by an operator.

When the oil pumped from a pump is supplied to a rod side of a cylinder via a direction switching valve and the discharge oil on the head side is returned to the direction switching valve, the amount of returning oil in relation to the amount of supplied oil per unit time is amplified and increased due to a difference in the cross-sectional area on the rod side and the head side of the cylinder. Moreover, when the returning oil is pushed by the load weight applied to the cylinder, the oil amount increases.

Due to an increase in the oil amount, a pressure loss of the returning oil passing through a switching spool of the direction switching valve increases. Thus, in a work machine that performs works by operating a large number of cylinders frequently, there are problems in that the operation speed of actuators decreases, the working efficiency deteriorates, and the fuel efficiency decreases due to a pressure increase on the supply side for compensating for the pressure loss.

A pressure loss reducing circuit that solves the pressure loss problems has been developed (for example, see Patent Document 1). The pressure loss reducing circuit will be described with reference to FIG. 5 (in which reference numerals are assigned to main components of FIG. 1 of Patent Document 1).

A direction switching valve 50 is connected to a head side 52a and a rod side 52b of a cylinder 52 by pipes 54 and 56, respectively, and is connected to a tank 58 by a pipe 60. The head-side pipe 54 and the rod-side pipe 56 are branched by bypass pipes 62 and 64, respectively so as to communicate with the tank 58. An electromagnetic variable relief valve 66 is installed in each of the bypass pipes 62 and 64. When one of the pipes 54 and 56 is controlled to be connected to the side where oil returns from the cylinder 52, a controller 68 puts the electromagnetic variable relief valve 66 of the pipe 54 or 56 into a low-load communication state so that the returning oil flows into the direction switching valve 50 and the tank 58 to decrease the amount of oil flowing into the direction switching valve 50 and to reduce a pressure loss.

Patent Document 1: Japanese Patent Application Publication No. 2010-242774 (FIG. 1)

### SUMMARY OF THE DISCLOSURE

The conventional pressure loss reducing circuit having the above-described configuration has the following problems that are to be solved.

That is, since a bypass pipe and an electromagnetic variable relief valve connected to a tank are added to a pipe that connects a direction switching valve and a cylinder, there are problems in that the manufacturing cost increases and an additional installation space is required.

With the foregoing in view, it is an object of the present invention to provide a pressure loss reducing circuit of a work machine capable of reducing a pressure loss of the oil returning from an actuator to a direction switching valve with a simple configuration while suppressing an increase in the manufacturing cost and substantially eliminating the need of an additional installation space.

In order to solve the problems, according to an aspect of the present invention, there is provided a pressure loss reducing circuit of a work machine, this circuit including: a direction switching valve that implement supply/discharge of oil pumped by a pump to/from an actuator via a switching spool; and a controller, wherein the direction switching valve includes: a pair of actuator oil paths that supplies the pumping oil to the actuator; a tank oil path that supplies oil returning from the actuator via the switching spool to the tank; and a bypass valve that is disposed between at least either one of the actuator oil paths and the tank oil path, and opened and closed according to a signal from the controller, and moreover screwed into and attached to a valve body of the direction switching valve, and in accordance with an operation signal for operating the switching spool when the oil returning from the actuator is caused to flow to an actuator oil path having a bypass valve, the controller opens the bypass valve so that the actuator oil path and the tank oil path communicate with each other, supplies the returning oil after bifurcation to the bypass valve to reduce a pressure loss of the returning oil.

Preferably, the bypass valve is a poppet-type flow regulating valve, and the bypass valve is closed by a poppet when the operation signal is not supplied and, when the operation signal is supplied, changes a flow rate according to a magnitude of the operation signal so that the actuator oil path and the tank oil path communicate with each other.

In another preferred embodiment, the bypass valve is a variable relief valve, and the bypass valve is set to a predetermined pressure when the operation signal is not supplied and, when the operation signal is supplied, decreases the setting pressure according to a magnitude of the operation signal so that the actuator oil path and the tank oil path communicate with each other.

Moreover, the work machine is a hydraulic shovel, the actuator is a bucket cylinder and an arm cylinder, and the actuator oil path having the bypass valve is connected to a head side of respective actuators.

The pressure loss reducing circuit of the work machine according to the present invention includes the bypass valve disposed between the actuator oil path and the tank oil path of the direction switching valve, opened and closed according to the signal from the controller, and screwed into and attached to the valve body of the direction switching valve. According to the operation signal of the switching spool when the oil returning from the actuator is caused to flow to the actuator oil path having the bypass valve, the controller opens the bypass valve so that the actuator oil path and the tank oil path communicate with each other.

Thus, the oil returning from the actuator is branched into both the spool and the bypass valve of the direction switching valve. Moreover, since a bypass pipe and an electromagnetic variable relief valve are not provided in the pipe that connects the direction switching valve and the cylinder, it is possible to reduce a pressure loss of the oil returning from the actuator to the direction switching valve with a simple configuration while suppressing an increase in the manufacturing cost and substantially eliminating the need of an additional installation space.

### BRIEF DESCRIPTION OF THE DRAWINGS

FIG. 1 is a circuit diagram of a pressure loss reducing circuit of a work machine configured according to the present invention.

FIG. 2 is a representative cross-sectional view of a direction switching valve illustrated in FIG. 1.

FIG. 3 is a circuit diagram of the pressure loss reducing circuit illustrated in FIG. 1 using another example of a bypass valve.

FIG. 4 is a characteristic diagram of a variable relief valve which is the bypass valve illustrated in FIG. 3.

FIG. 5 is a circuit diagram of a conventional pressure loss reducing circuit.

FIG. 6 is a side view of a hydraulic shovel which is a typical example of a work machine to which the pressure loss reducing circuit is applied.

### BEST MODE FOR CARRYING OUT THE INVENTION

Hereinafter, a pressure loss reducing circuit of a work machine configured according to the present invention will be described in more detail with reference to the accompanying drawings illustrating a preferred embodiment.

First, a hydraulic shovel which is a typical example of a work machine to which a pressure loss reducing circuit is applied will be described with reference to FIG. 6. A hydraulic shovel 70 includes a lower traveling structure 72 and an upper revolving structure 74, and a working arm device 76 having a large number of hydraulic actuators is provided on the upper revolving structure 74.

The working arm device 76 includes a boom 76a attached to the upper revolving structure 74 so as to swing in a vertical direction, an arm 76b attached to a distal end of the boom 76a so as to swing in the vertical direction, and a bucket 76c attached to a distal end of the arm 76b so as to swing in the vertical direction. The working arm device 76 further includes a boom cylinder 76d which is an actuator that swings the boom 76a, an arm cylinder 76e that swings the arm 76b, and a bucket cylinder 76f that swings the bucket 76c.

In order to efficiently perform a work using the bucket 76c, which is a typical work of the hydraulic shovel 70, quick stretching and contracting operations of the arm cylinder 76e and the bucket cylinder 76f are required. Thus, a pressure loss reducing circuit that reduces a pressure loss of the oil returning from the head side of the cylinder, which decelerates the operation speed when opening the bucket 76c (the opening movement is indicated by arrow “X”) and pushing the arm 76b (indicated by arrow “Y”) is included.

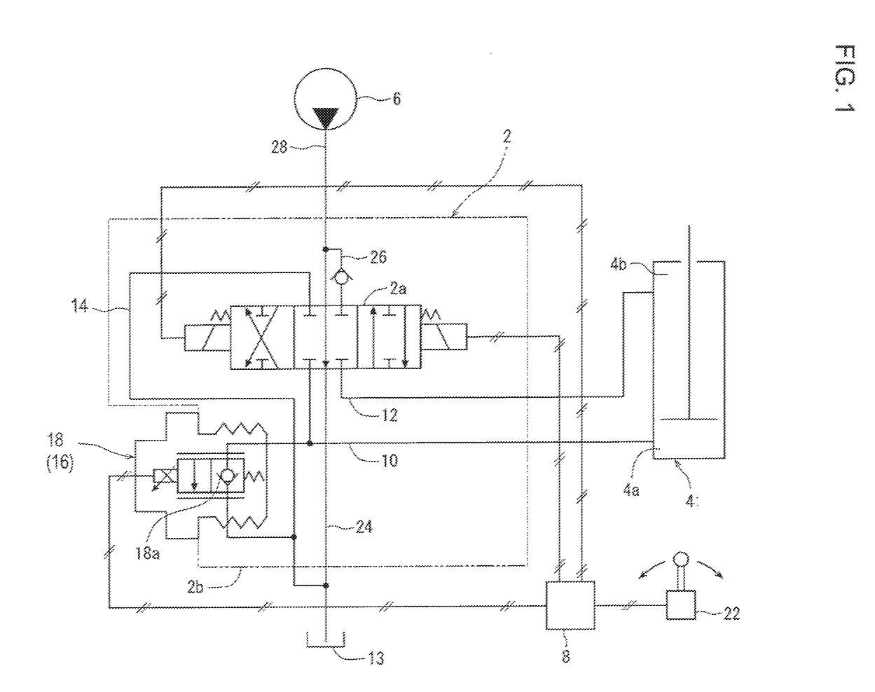

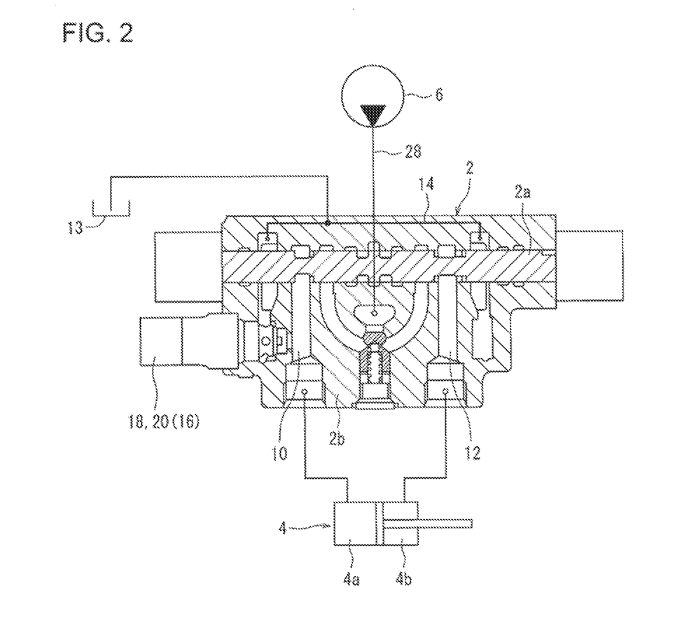

Explanation is provided with reference to FIGS. 1 and 2 (mainly FIG. 1). The pressure loss reducing circuit includes a direction switching valve 2 that supplies the oil pumped from a pump 6 to a cylinder 4 via a switching spool 2a and a controller 8.

The direction switching valve 2 in itself includes: a head-side oil path 10 and a rod-side oil path 12 that supplies pumping oil to a head side 4a and a rod side 4b, respectively, which are a pair of actuator oil paths that implements supply/discharge of the pumping oil to/from the cylinder 4, a tank oil path 14 that supplies oil returning from the cylinder 4 to a tank 13 via the switching spool 2a, and a bypass valve 16 that is disposed between the head-side oil path 10 which is one actuator oil path and the tank oil path 14, opened and closed according to a signal from the controller 8, and screwed into and attached to the valve body 2b of the direction switching valve 2.

The direction switching valve 2 except the bypass valve 16 is a known electromagnetic direction switching valve having three positions of “Cylinder Stretch,” “Neutral,” and “Cylinder Contraction”. The position of the switching spool 2a is changed from the “Neutral” position to the respective positions according to the magnitude of an operation signal from the controller 8 based on an operation of a lever 22 operated by the operator.

The direction switching valve 2 includes a central bypass oil path 24 and a parallel supply oil path 26. The central bypass oil path 24 is connected to a pumping oil path 28 of the pump 6. When the switching spool 2a is at the “Neutral” position (the illustrated position), the central bypass oil path 24 is connected to the tank 13 while passing through the pumping oil path 28 and the communication between the pump 6 and the head-side oil path 10 and the rod-side oil path 12 is blocked. The parallel supply oil path 26 is connected to the pumping oil path 28 of the pump 6. When the switching spool 2a is at the “Neutral” position, the parallel supply oil path 26 is closed by the switching spool 2a. When the switching spool 2a is switched to the “Cylinder Stretch” position or the “Cylinder Contraction” position, the pumping oil is supplied to the head-side oil path 10 or the rod-side oil path 12 via the switching spool 2a and the oil returning from the cylinder 4 is supplied to the tank oil path 14.

The controller 8 opens the bypass valve 16 according to an operation signal of the operating lever 22 that operates the switching spool 2a when the oil returning from the cylinder 4 is caused to flow to the head-side oil path 10 which is an actuator oil path having a bypass valve (during cylinder contraction) so that the head-side oil path 10 and the tank oil path 14 communicate with each other.

The bypass valve 16 is a poppet-type flow regulating valve 18 (more specifically, an electromagnetic proportional flow regulating valve) and is screwed into and attached to a female screw hole of the valve body 2b.

The poppet-type flow regulating valve 18 changes the flow rate in proportion to the magnitude of the operation signal which is an electrical signal from the controller 8. When the operation signal is not supplied, the communication between the actuator oil path 10 and the tank oil path 14 is blocked with the aid of a poppet 18a. When the operation signal is supplied, the actuator oil path 10 and the tank oil path 14 communicate with the flow rate corresponding to the signal.

That is, according to the operation signal from the controller 8 based on an operation amount of the operating lever 22 for creating a state where the switching spool 2a of the direction switching valve 2 is completely switched from the “Neutral” position to the “Cylinder Contraction” position, the poppet-type flow regulating valve 18 regulates the flow rate to allow the flow of oil to the tank oil path 14. When the spool 2a is at the “Neutral” position or the “Cylinder Stretch” position where the pumping oil is supplied to the head side 4a, the flow of oil from the head-side oil path 10 to the tank oil path 14 is stopped by the poppet 18a.

As the poppet-type flow regulating valve 18, commercial products sold by the name of “cartridge-type, poppet-type, and threaded-type electromagnetic proportional flow control valves” can be used. Thus, description of detailed structures thereof will not be provided.

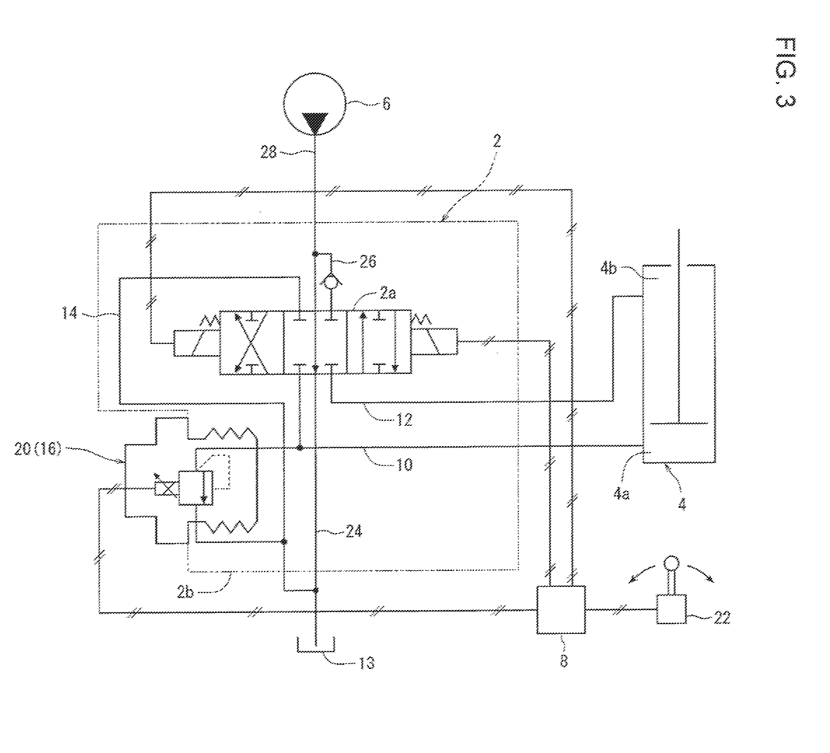

Next, the pressure loss reducing circuit that uses a variable relief valve 20 which is another example of the bypass valve 16 will be described with reference to FIGS. 2 and 3 (mainly FIG. 3). Since FIG. 3 is the same as FIG. 2 except for the variable relief valve 20, the same reference numerals are assigned and the description thereof will not be provided.

The variable relief valve 20 is a known electromagnetic proportional relief valve and is screwed into and attached to a female screw hole of the valve body 2b.

The variable relief valve 20 receives an electrical signal for regulating a setting pressure corresponding to the operation signal of the operating lever 22 from the controller 8, and the pressure is changed according to the magnitude of the operation signal of the operating lever 22. When the operation signal is not supplied, the communication between the actuator oil path 10 and the tank oil path 14 is blocked according to the high setting pressure. When the operation signal is supplied, the pressure is decreased according to the magnitude of the operation signal and the actuator oil path 10 and the tank oil path 14 communicate with each other.

That is, according to the operation signal from the controller 8 based on the operation amount of the operating lever 22 for creating a state where the switching spool 2a of the direction switching valve 2 is completely switched from the “Neutral” position to the “Cylinder Contraction” position, the variable relief valve 20 adjusts the pressure and decreases the same to enable the oil to flow to the tank oil path 14. When the spool 2a is at the “Neutral” position or the “Cylinder Stretch” position where the pumping oil is supplied to the head side 4a, the flow of oil from the head-side oil path 10 to the tank oil path 14 is stopped by the high setting pressure.

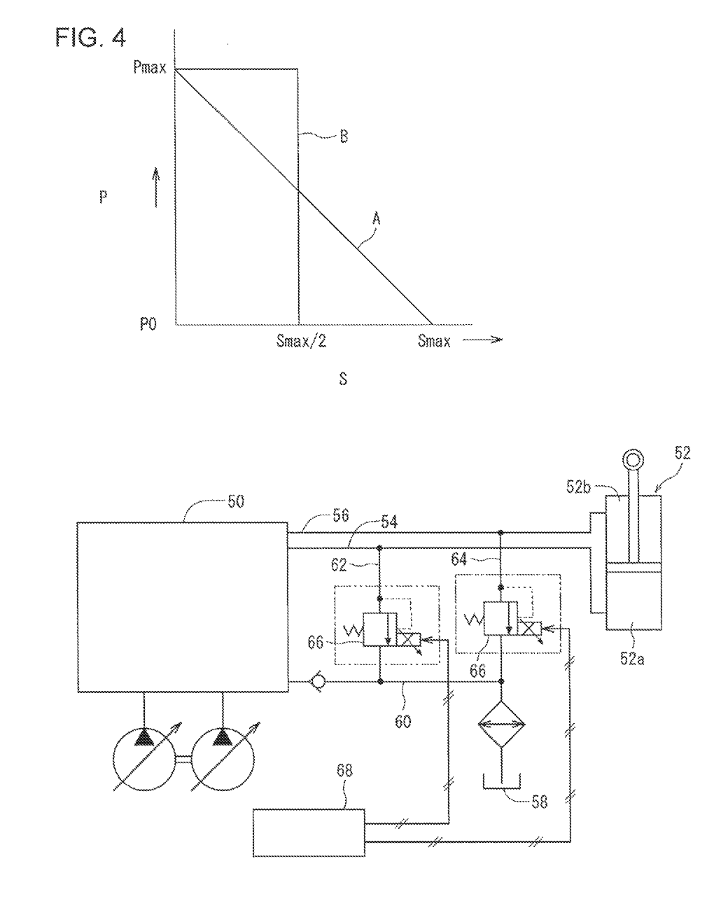

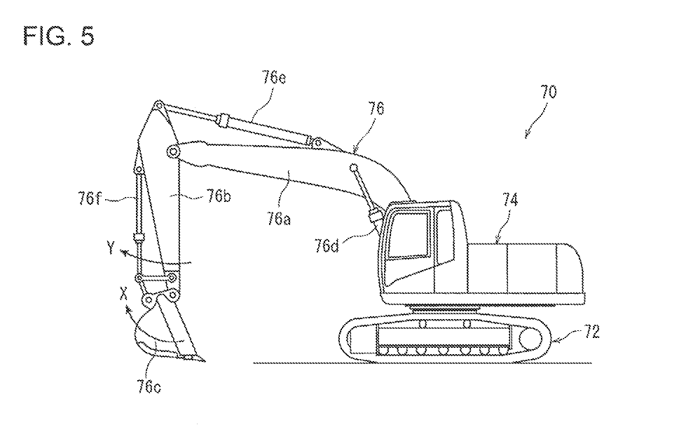

How the pressure of the variable relief valve 20 is set will be described with reference to FIG. 4. The setting pressure can be appropriately set according to a mode in which the actuator is used in the work machine, the state of a pressure loss, and the like.

For example, as indicated by characteristic line “A” in FIG. 4, the setting pressure is set by a continuous straight line extending from a maximum pressure Pmax when an operation signal S is not supplied to a smallest pressure P0 when a maximum operation signal Smax is supplied. When no returning oil is present in the head-side oil path 10 and the operation signal S is not supplied, the communication between the head-side oil path 10 and the tank oil path 14 is closed by the high pressure Pmax. When the amount of returning oil increases with the magnitude of the operation signal S, the setting pressure P is decreased and the amount of oil flowing from the head-side oil path 10 to the tank oil path 14 is increased.

As indicated by characteristic line “B” in FIG. 4, the setting pressure is set in two steps so that the setting pressure is Pmax when the operation signal S is not supplied until the operation signal S reaches Smax/2 which is half of the maximum operation signal Smax and that the setting pressure is the smallest pressure PO when the operation signal S exceeds Smax/2 and reaches the maximum operation signal Smax. When the operation signal S is between 0 and Smax/2, the communication between the head-side oil path 10 and the tank oil path 14 is closed by the high pressure Pmax. When the operation signal S exceeds Smax/2 and the amount of returning oil increases, the setting pressure P is decreased to the minimum pressure PO so that the returning oil flows from the head-side oil path 10 to the tank oil path 14.

The operation and effects of the pressure loss reducing circuit of the work machine will be described.

The pressure loss reducing circuit of the work machine according to the present invention includes the bypass valve 16 disposed between the actuator oil path 10 and the tank oil path 14 of the direction switching valve 2, opened and closed according to the signal from the controller 8, and screwed into and attached to the valve body 2b of the direction switching valve 2. According to the operation signal of the switching spool 2a when the oil returning from the actuator 4 is caused to flow to the actuator oil path 10 having the bypass valve 16, the controller 8 opens the bypass valve 16 so that the actuator oil path 10 and the tank oil path 14 communicate with each other.

Thus, the oil returning from the actuator 4 is branched into both the spool 2a and the bypass valve 16 of the direction switching valve 2 and flows into the tank 13. Moreover, since a bypass pipe and an electromagnetic variable relief valve are not provided in the pipe that connects the direction switching valve 2 and the actuator 4, it is possible to reduce a pressure loss of the oil returning from the actuator 4 to the direction switching valve 2 with a simple configuration and assembly using a small number of components while suppressing an increase in the manufacturing cost and substantially eliminating the need of an additional installation space.

Further, by setting the bypass valve 16 (the poppet-type flow regulating valve 18 or the variable relief valve 20), when the amount of oil returning from the actuator 4 is small due to a very small operation amount of the operating lever 22, it is possible to decrease the amount of oil passing through the bypass valve 16. Alternatively, when the flow is to be stopped, the actuator 4 can be controlled to operate very slightly using the spool 2a of the direction switching valve 2.

The bypass valve 16 of the pressure loss reducing circuit of the work machine according to the present invention is the poppet-type flow regulating valve 18 and is configured to be closed by the poppet 18a when the operation signal is not supplied and to change the flow rate according to the magnitude of the operation signal so that the actuator oil path 10 and the tank oil path 14 communicate with each other when the operation signal is supplied.

Thus, the poppet-type flow regulating valve 18 regulates the flow rate as the bypass valve. Moreover, the poppet-type flow regulating valve 18 reliably blocks the operation pressure or the block pressure of the head side 4a of the cylinder 4 when the cylinder 4 is stretched or the cylinder 4 is not operated but held, using the poppet 18a to reliably prevent the oil from flowing into the tank oil path 14.

Moreover, in a state where the cylinder 4 is stretched or the cylinder 4 is not operated but held, when the cylinder 4 is caused to be stretched due to an external load or the like, the poppet-type flow regulating valve 18 may act as a valve that supplies the hydraulic oil from the tank oil path 14 to the head side 4a.

Another embodiment of the bypass valve 16 of the pressure loss reducing circuit of the work machine is the variable relief valve 20 which is set to a predetermined pressure when the operation signal is not supplied and which decreases the setting pressure according to the magnitude of the operation signal so that the actuator oil path and the tank oil path communicate with each other when the operation signal is supplied.

Thus, the variable relief valve 20 regulates the flow rate as a bypass valve. Moreover, the variable relief valve 20 can relieve an operation pressure or a block pressure of the head side 4a of the cylinder 4 when the cylinder 4 is stretched or the cylinder 4 is not operated but held, to a predetermined pressure and can regulate the flow of oil to the tank oil path 14 continuously or gradually according to the pressure setting.

In the pressure loss reducing circuit of the work machine according to the present invention, the work machine is a hydraulic shovel, and the actuator is a bucket cylinder and an arm cylinder.

Thus, a bucket operation using the arm cylinder and the brake control circuit, which is a typical operation of the hydraulic shovel of the work machine, can be quickly performed with high efficiency while reducing a pressure loss.

While the present invention has been described in detail based on the embodiment, the present invention is not limited to the embodiment, but various alterations or modifications as below can be made within the scope of the present invention.

In the embodiment of the present invention, although the bypass valve 16 is provided in one head-side oil path 10 of the pair of actuator oil paths 10 and 12, the bypass valve may be provided in the other rod-side oil path 12 or both according to the form of the work machine.

Although the bypass valve 16 in the embodiment of the present invention is the poppet-type flow regulating valve 18 (or the variable relief valve 20), another appropriate on-off valve (for example, an on/off switching valve) may be used.

Although the direction switching valve 2 in the embodiment of the present invention is an electromagnetic direction switching valve, the direction switching valve may be a hydraulic pilot-type direction switching valve or a manual direction switching valve.

### EXPLANATION OF REFERENCE NUMERALS

2: Direction switching valve

2a: Switching spool

4: Cylinder (Actuator)

6: Pump

8: Controller

10: Head-side oil path (Actuator oil path)

12: Rod-side oil path (Actuator oil path)

13: Tank

14: Tank oil path

16: Bypass valve

18: Poppet-type flow regulating valve (Bypass valve)

20: Variable relief valve (Bypass valve)

70: Hydraulic shovel (Work machine)

76e: Arm cylinder (Actuator)

76f: Bucket cylinder (Actuator)

1. A pressure loss reducing circuit of a work machine, the circuit comprising:
a direction switching valve that implements supply/discharge of oil pumped by a pump to/from an actuator via a switching spool; and
a controller, wherein
the direction switching valve includes:
a pair of actuator oil paths that supplies the pumping oil to the actuator;
a tank oil path that supplies oil returning from the actuator via the switching spool to the tank; and
a bypass valve that is disposed between at least either one of the actuator oil paths and the tank oil path, and opened and closed according to a signal from the controller, and moreover screwed into and attached to a valve body of the direction switching valve, and
in accordance with an operation signal for operating the switching spool when the oil returning from the actuator is caused to flow to an actuator oil path having a bypass valve, the controller opens the bypass valve so that the actuator oil path and the tank oil path communicate with each other, supplies the returning oil after bifurcation to the bypass valve to reduce a pressure loss of the returning oil.

2. The pressure loss reducing circuit of a work machine according to claim 1, wherein
the bypass valve is a poppet-type flow regulating valve, and
the bypass valve is closed by a poppet when the operation signal is not supplied and, when the operation signal is supplied, changes a flow rate according to a magnitude of the operation signal so that the actuator oil path and the tank oil path communicate with each other.

3. The pressure loss reducing circuit of a work machine according to claim 1, wherein
the bypass valve is a variable relief valve, and
the bypass valve is set to a predetermined pressure when the operation signal is not supplied and, when the operation signal is supplied, decreases the setting pressure according to a magnitude of the operation signal so that the actuator oil path and the tank oil path communicate with each other.

4. The pressure loss reducing circuit of a work machine according to any one of claim 1, wherein
the work machine is a hydraulic shovel,
the actuator is a bucket cylinder and an arm cylinder, and
the actuator oil path having the bypass valve is connected to a head side of respective actuators.
